(19) United States
(12) Patent Application Publication
(10) Pub. No.: US 2026/0014915 A1
(43) Pub. Date: Jan. 15, 2026

(54) LEG REST DEVICE FOR VEHICLES AND A DRIVING METHOD THEREOF

(71) Applicants: HYUNDAI MOTOR COMPANY, Seoul (KR); KIA CORPORATION, Seoul (KR); HYUNDAI TRANSYS INC., Seosan-si (KR)

(72) Inventors: Gu Chang Kang, Hwaseong-si (KR); Ui Jeong Lee, Hwaseong-si (KR); Sang In Woo, Hwaseong-si (KR); Hyun Geun Yoon, Busan (KR); Dong Yeon Choi, Busan (KR); Soo Bok Kim, Hwaseong-si (KR); Ji Yun Ha, Hwaseong-si (KR); Sang Hark Lee, Hwaseong-si (KR); Eun Sue Kim, Hwaseong-si (KR); Jung Sang You, Hwaseong-si (KR)

(73) Assignees: HYUNDAI MOTOR COMPANY, Seoul (KR); KIA CORPORATION, Seoul (KR); HYUNDAI TRANSYS INC., Seosan-si (KR)

(21) Appl. No.: 19/259,886

(22) Filed: Jul. 3, 2025

(30) Foreign Application Priority Data
Jul. 9, 2024 (KR) 10-2024-0090022

(51) Int. Cl. B60N 2/90; B60N 2/02

(52) U.S. Cl. CPC B60N 2/995; B60N 2/02

(57) ABSTRACT

A leg rest device is for a vehicle and installed in a vehicle seat. The leg rest device for vehicles includes a seat leg rest configured to support calves of a passenger, a driver located on a lower surface of the seat leg rest and configured to rotate the seat leg rest forward, and a controller configured to transmit a control signal to the driver and drive the driver by the control signal. The driver includes an air bag, and air is injected into the air bag based on the control signal from the controller so that the air bag is inflated to rotate the seat leg rest forward.

### CROSS-REFERENCE TO RELATED APPLICATION

This application claims under 35 U.S.C. § 119(a) the benefit of and priority to Korean Patent Application No. 10-2024-0090022 filed on Jul. 9, 2024, the entire contents of which are incorporated herein by reference.

### TECHNICAL FIELD

The present disclosure relates to a leg rest device for vehicles and a driving method thereof. More particularly, it relates to a leg rest device capable of raising and lowering passenger's calves.

### BACKGROUND

In general, various convenience devices are installed on the seats of vehicles to enable users to maintain a more comfortable seating position. Among these convenience devices, a leg rest is installed on a seat cushion so that the lower part of the seat cushion is rotatable forward, so that legs of a user sitting on the seat cushion may be maintained in a comfortable position.

The leg rest is configured to be basically inserted into the lower part of the seat when not in use and to extend forward from the seat depending on the operation of a driver to support passenger's legs when necessary.

In the conventional leg rest, a plate that supports passenger's legs has a four-section link structure between the plate and a seat, so there are many components to drive the leg rest, and an area occupied by the movement trajectory of the four-section link structure during operation is large, which makes it difficult to design freely the leg rest within a narrow space between a vehicle floor and the bottom of the seat.

In addition, a motor and frame structure for implementing the conventional seat leg rest occupies an excessive area in a package within the seat, and thus causes the weight of the vehicle to increase excessively. Recently, as the electric vehicle industry has developed, there is a growing interest in securing a battery space in the lower portion of the vehicle and improving energy efficiency, and these problems of the conventional technology may be considered as counter to recent industry trends.

In addition, in order to operate the leg rest, a plurality of link frames of the link structure is operated through the motor, and in this process, interference between components may occur, and workability may be reduced due to the excessive number of components.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with the prior art. The present disclosure may provide a leg rest device for vehicles that may secure a space within a vehicle by reducing a component package for driving a leg rest.

The present disclosure may also provide a leg rest device for vehicles that prevents interference between a motor for rotating the leg rest device forward and a plurality of link structures, and does not cause malfunction or noise due to interference between components.

The present disclosure may further provide a leg rest device for vehicles that does not reduce workability due to an excessive number of component packages for driving the leg rest device.

The objects of the present disclosure are not limited to the above-mentioned objects, and other objects not mentioned herein should be clearly understood by those having ordinary skill in the art from the following description and be more clearly understood from embodiments of the present disclosure. In addition, the objects of the present disclosure may be realized by means and combinations thereof disclosed in the claims.

In one aspect of the present disclosure, a leg rest device includes: a seat leg rest configured to support calves of a passenger, a driver operatively associated with the seat leg rest and configured to rotate the seat leg rest forward, and a controller configured to transmit a control signal to the driver to operate the driver. The driver includes an air bag, and the air bag is configured to be inflated by air injected into the air bag based on the control signal from the controller to rotate the seat leg rest forward. The leg rest device may be for a vehicle and installed in a vehicle seat.

In an embodiment, when air is exhausted from the air bag or based on that air is exhausted from the air bag, the air bag may be configured to be deflated to rotate the seat leg rest backward.

In an embodiment, the driver may further include at least one pneumatic plate coupled to the seat leg rest, a bracket assembled with the seat leg rest, a hinge pipe located between the at least one pneumatic plate and the bracket, a webbing strap connected to ends of the at least one pneumatic plate and the bracket and configured to increase a distance between the at least one pneumatic plate and the bracket, a pump configured to supply air into the air bag, and a leg rest link configured to raise the seat leg rest forward by the air bag. The air bag may be provided on the at least one pneumatic plate. A reaction force may be generated between the at least one pneumatic plate and the bracket through inflation or deflation of the air bag, and the seat leg rest may be configured to rotate forward due to or based on the reaction force.

In an embodiment, the driver may further include a webbing strap configured to adjust a position of the seat leg rest, and a leg rest link configured to raise the seat leg rest forward. An angle of the seat leg rest may be controlled in response to or based on a length of the webbing strap.

In an embodiment, the air bag may be configured to be inflated with air by a pump to push the at least one pneumatic plate.

In an embodiment, the at least one pneumatic plate may be configured to be pushed by the air bag, so that tensile force is generated in the webbing strap coupled to the at least one pneumatic plate.

In an embodiment, the leg rest device may further include a leg rest pipe coupled to the leg rest link and configured to fold or unfold the leg rest link.

In an embodiment, the webbing strap may be configured to lift the leg rest pipe to raise the leg rest link so that the distance between the at least one pneumatic plate and the bracket increases.

In an embodiment, the air bag may be coupled to an air hose, and the air hose may be configured to be used as a flow path such that air is supplied into or exhausted from the air bag through the flow path or the air hose based on the control signal from the controller.

In an embodiment, the air bag may include an air hose rib configured to serve as a guide configured to prevent the air hose from being removed.

In an embodiment, the leg rest device may further include an air hose bracket configured to fix the air hose.

In an embodiment, the leg rest device may further include a male connector connected to the air hose, and a female connector connected to the male connector. The air hose may be located adjacent to the male connector and the female connector.

In an embodiment, the leg rest device may further include an air hose bracket configured to fix a path of the air hose.

In an embodiment, the leg rest device may further include a first fastener configured to fix the air hose bracket to a seat cushion configured to come into contact with at least one thigh of the passenger.

In an embodiment, the leg rest device may further include a second fastener configured to fix the air hose to a frame of a vehicle.

In another aspect of the present disclosure, a driving method of a leg rest device includes: inflating an air bag connected to an air hose; generating a reaction force between the air bag and a bracket; increasing an angle between a hinge pipe and a pneumatic plate located adjacent to the air bag and spaced apart from the bracket; generating tensile force in a webbing strap coupled to the bracket and the pneumatic plate; lifting a leg rest pipe, rotating a seat leg rest forward; stopping the inflation of the air bag; measuring an angle of the seat leg rest; determining whether the angle of the set leg rest reaches a set angle; and inflating the air bag based on a determination that the angle of the seat leg rest does not reach the set angle.

In an embodiment, the reaction force between the air bag and the bracket may be generated based on inflation of the air bag or as the air bag is inflated.

In yet another aspect of the present disclosure, a leg rest device includes: a seat leg rest configured to support calves of a passenger; a driver operatively associated with the seat leg rest and including an air bag; and a controller configured to cause the driver to inflate the air bag to rotate the seat leg rest forward.

In an embodiment, the air bag may be configured to be deflated to rotate the seat leg rest backward.

In an embodiment, the driver may further include: at least one pneumatic plate coupled to the seat leg rest, wherein the air bag is provided on the at least one pneumatic plate; and a bracket assembled with the seat leg rest. A reaction force may be generated between the at least one pneumatic plate and the bracket through inflation or deflation of the air bag, and the seat leg rest is configured to rotate forward based on the reaction force.

Other aspects and embodiments of the disclosure are discussed below.

The above and other features of the disclosure are discussed below.

### BRIEF DESCRIPTION OF THE DRAWINGS

The above and other features of the present disclosure are now be described in detail with reference to embodiments thereof illustrated in the accompanying drawings which are given hereinbelow by way of illustration only, and thus are not limitative of the present disclosure, and wherein:

FIG. 1A is a view showing the appearance of a leg rest device for vehicles before rotation, and FIG. 1B is a view showing the appearance of the leg rest of the vehicle after rotation;

FIG. 2A is a view showing the appearance of the leg rest device for vehicles before rotation, and FIG. 2B is a cross-sectional view of FIG. 2A taken along line A-A′;

FIG. 3A is a view showing the appearance of the leg rest device for vehicles after rotation, and FIG. 3B is a cross-sectional view of FIG. 3A taken along line B-B′;

FIG. 4 is a perspective view showing the rear surface of the leg rest device for vehicles, and illustrates an enlarged view showing fixing devices for an air hose;

FIG. 5A is a perspective view showing the bottom surface of the leg rest device for vehicles, FIG. 5B is a view showing a coupling structure of the air hose, FIG. 5C is a view showing a rib of the air hose, and FIG. 5D is a view showing first fasteners; and

FIG. 6 is a flowchart illustrating a driving method of the leg rest device for vehicles according to an embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes, will be determined in part by the particular intended application and use environment. The drawings described herein are for illustration purposes only and are not intended to limit the scope of the present disclosure in any way.

In the figures, reference numbers refer to the same or equivalent parts of the present disclosure throughout the several figures of the drawing.

### DETAILED DESCRIPTION

Hereinafter, reference is made in detail to various embodiments of the present disclosure, examples of which are illustrated in the accompanying drawings and described below. The present disclosure is not limited to the following embodiments, and embodiments may be implemented in various different forms. The following embodiments are provided to make the description of the present disclosure thorough and to fully convey the scope of the present disclosure to those having ordinary skill in the art.

In addition, in the following description of embodiments, it should be understood that the terms “ . . . part,” “ . . . unit,” “ . . . module,” and the like indicate units for processing at least one function or operation, and may be implemented as software, hardware, or a combination of software and hardware.

In addition, the terminology used herein is for the purpose of describing particular embodiments only and is not intended to be limiting. As used herein, singular expressions may be intended to include plural expressions as well, unless the context clearly indicates otherwise.

In addition, in the following description, terms, such as “first,” “second,” and the like, are used only to distinguish various elements having the same name, and do not imply a sequence or order unless clearly indicated by the context. When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

Hereinafter, embodiments are described in detail with reference to the accompanying drawings, and when describing with reference to the accompanying drawings, the same reference numerals are given to identical or corresponding components, and redundant descriptions thereof have been omitted.

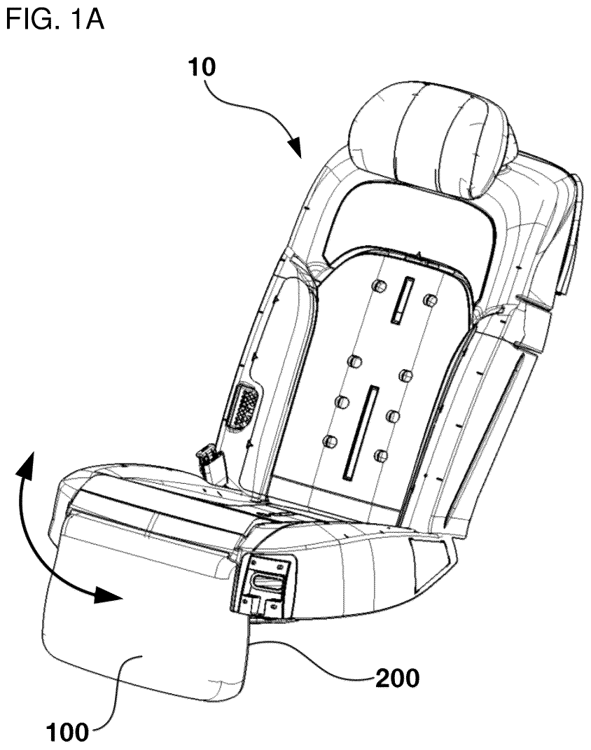

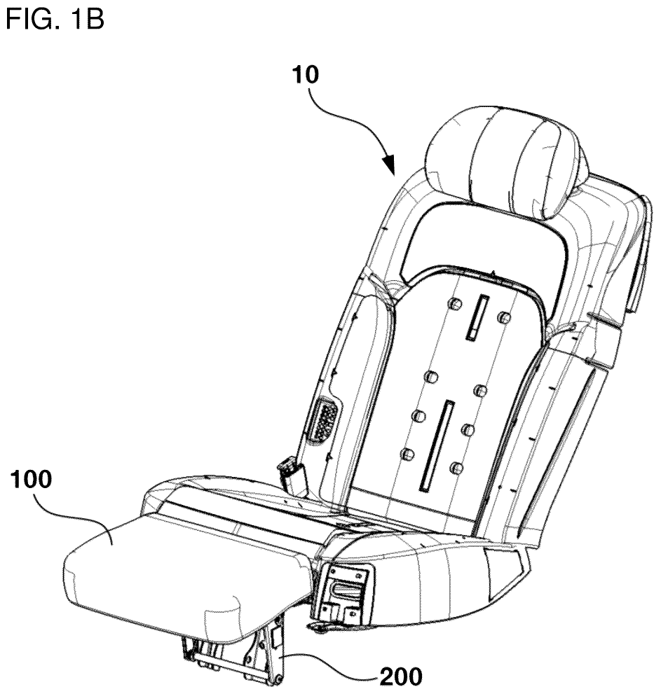

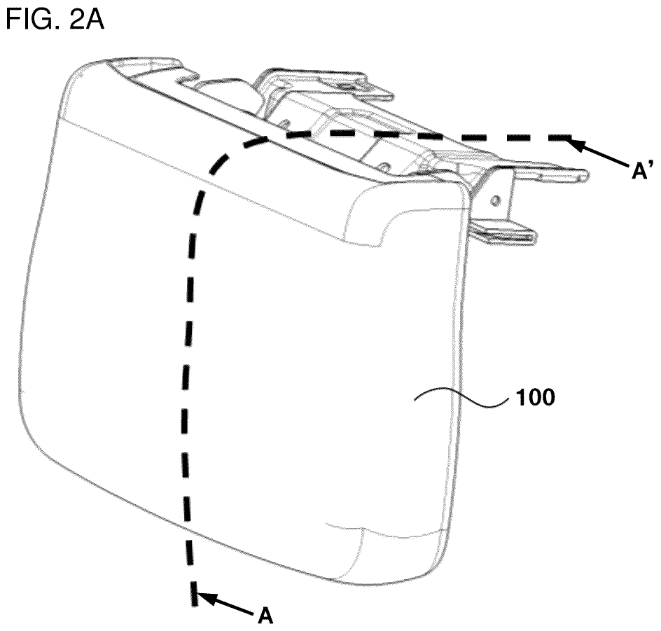

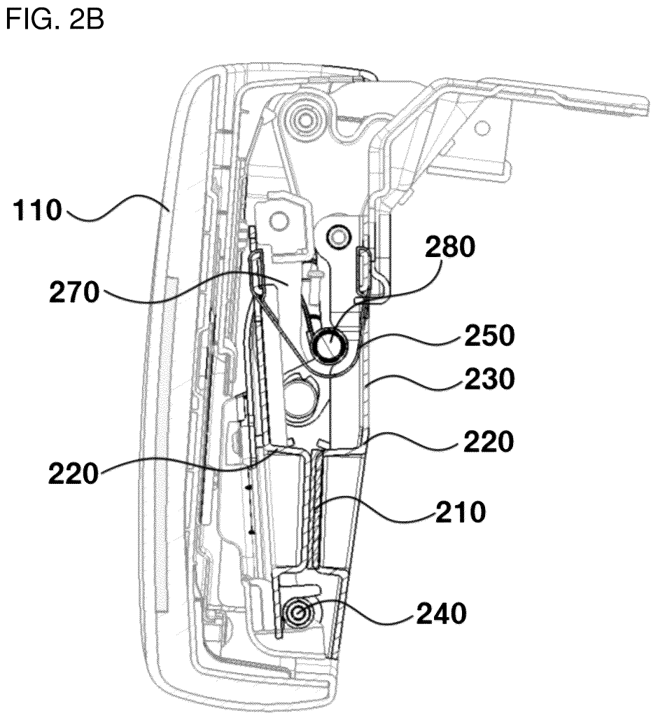

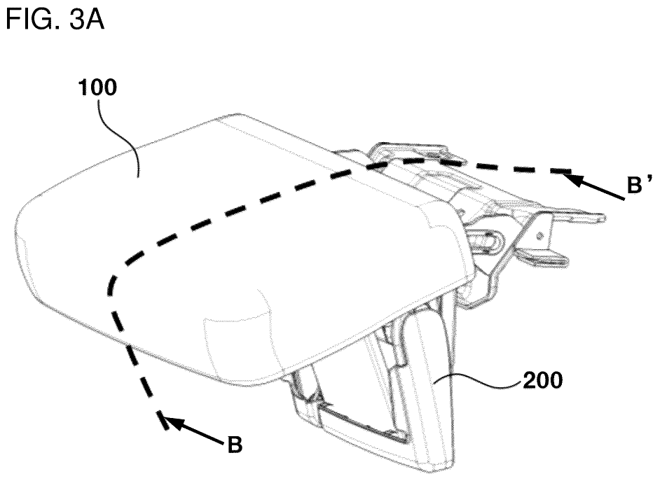

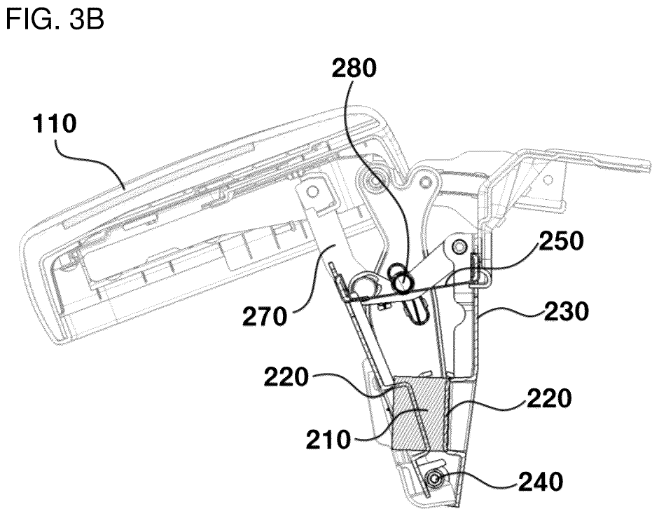

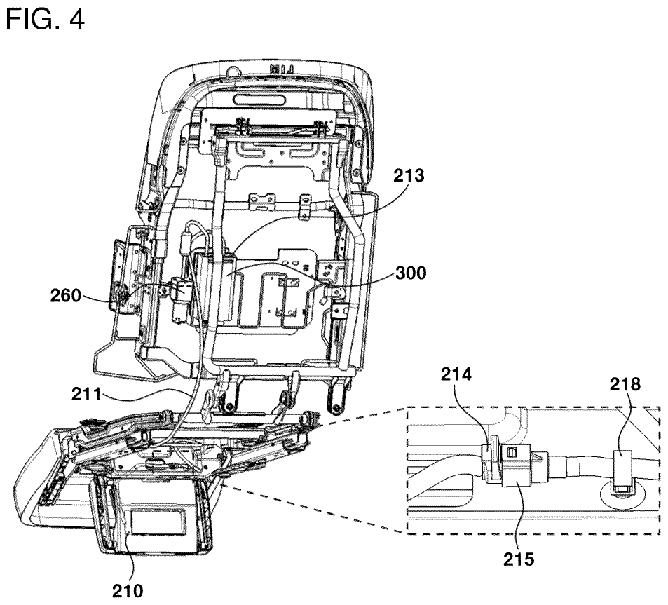

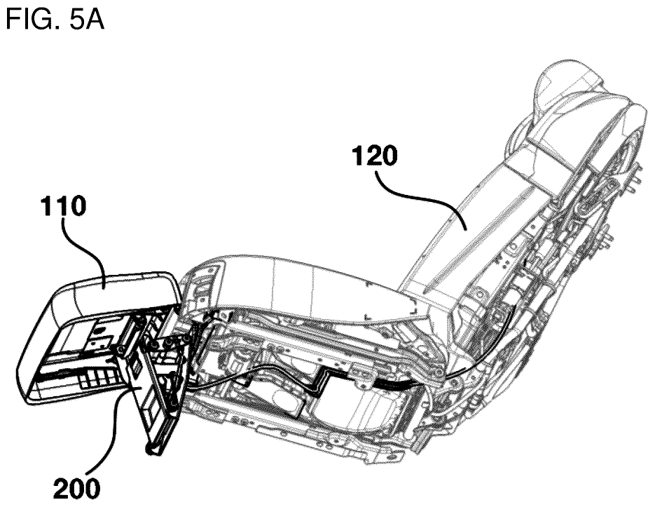

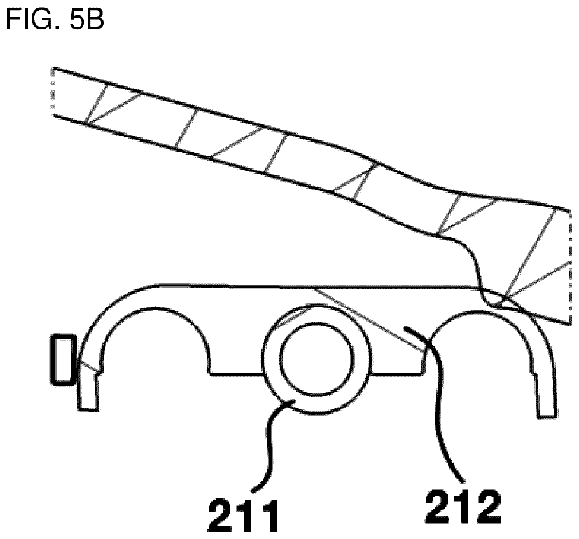

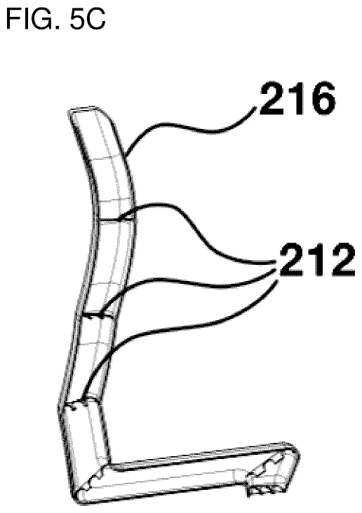

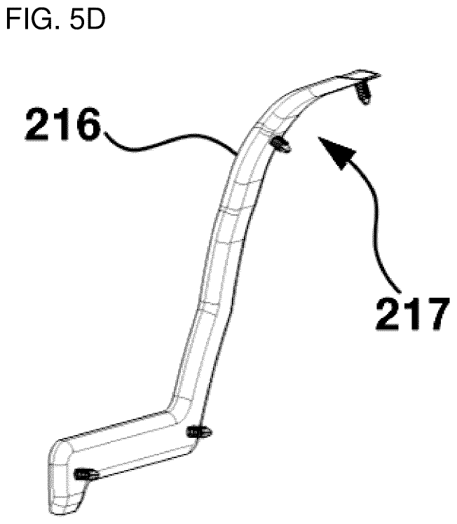

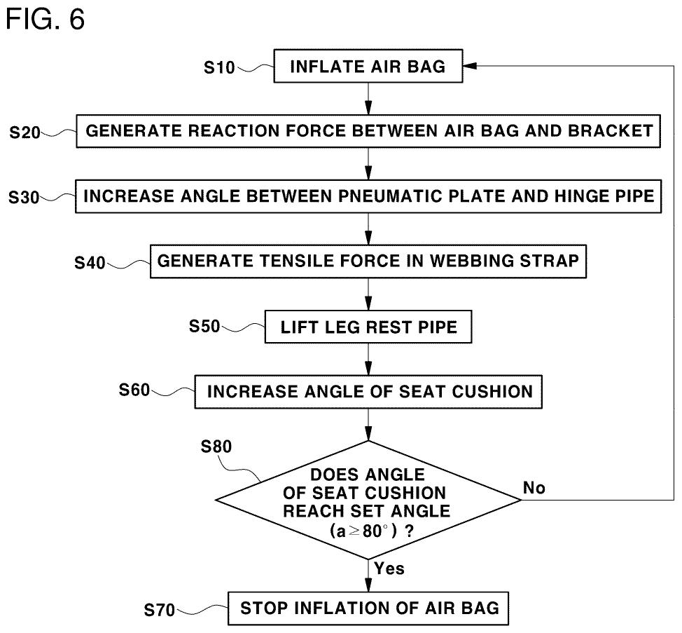

FIG. 1A is a view showing the appearance of a leg rest device for vehicles before rotation. FIG. 1B is a view showing the appearance of the leg rest of the vehicle after rotation. FIG. 2A is a view showing the appearance of the leg rest device for vehicles before rotation. FIG. 2B is a cross-sectional view of FIG. 2A taken along line A-A′. FIG. 3A is a view showing the appearance of the leg rest device for vehicles after rotation. FIG. 3B is a cross-sectional view of FIG. 3A taken along line B-B′. FIG. 4 is a perspective view showing the rear surface of the leg rest device for vehicles and illustrates an enlarged view showing fixing devices for an air hose. FIG. 5A is a perspective view showing the bottom surface of the leg rest device for vehicles. FIG. 5B is a view showing a coupling structure of the air hose. FIG. 5C is a view showing a rib of the air hose. FIG. 5D is a view showing first fasteners. and FIG. 6 is a flowchart illustrating a driving method of the leg rest device for vehicles of the present disclosure in detail.

Referring to FIGS. 1A-4, the present disclosure relates to a leg rest device 10 installed in a vehicle, which includes a seat leg rest 100, a driver 200, and a

The leg rest device 10 may be normally maintained in a state in which the seat leg rest 100 is folded downward, as shown in FIG. 1A, and be converted into a state in which the seat leg rest 100 is unfolded upward and then fixed by operating the controller 300 according to user's needs, as shown in FIG. 1B. In addition, the leg rest device 10 of the present disclosure may be operated such that the seat leg rest 100 is unfolded forward or folded backward through inflation or deflation of an air bag 210. Hereinafter, components included in the driver 200 to move the seat leg rest 100 are described in detail.

The driver 200 according to one embodiment of the present disclosure includes the air bag 210, a pneumatic plate 220, a bracket 230, a hinge pipe 240, a webbing strap 250, a pump 260, a leg rest link 270, and a leg rest pipe 280.

First, the air bag 210 of the driver 200 according to one embodiment of the present disclosure may be configured to be inflated or deflated using air through an air hose 211 by driving the pump 260, which is described below, to push or not to push the pneumatic plate 220.

Specifically, if a passenger wants to rotate the seat leg rest 100 supporting the passenger's calves forward at a designated angle, the passenger applies an electrical signal to the controller 300, and the controller 300 causes air to be supplied into the air bag 210.

In addition, the volume of the air bag 210 of the driver 200 may be set by controlling air to be supplied into or exhausted from the air bag 210, and the angle of the seat leg rest 100 may be adjusted depending on the volume of the air bag 210. For example, if a passenger wants to rotate the seat leg rest 100 supporting the passenger's calves forward by a designated angle, a larger amount of air may be supplied into the air bag 210 using the controller 300 so that the pneumatic plate 220 coupled to the air bag 210 may be rotated upward at a larger angle. In this way, the angle of the leg rest device 10 may be implemented depending on the passenger's preference by controlling air supply or exhaust into or from the air bag 210.

The driver 200 according to one embodiment of the present disclosure may include at least one pneumatic plate 220, the air bag 210 may be located between the at least one pneumatic plate 220 and the bracket 230, and as the air bag 210 is inflated, a distance between the pneumatic plate 220 and the bracket 230 may increase. In addition, as the amount of air supplied into the air bag 210 increases, the distance between the pneumatic plate 220 and the bracket 230 may further increase.

In addition, the bracket 230 of the driver 200 according to one embodiment of the present disclosure is located under the lower portion of the seat leg rest 100, is welded to a lower frame of the seat leg rest 100, and serves to apply a reaction force to the pneumatic plate 220.

Further, the hinge pipe 240 of the driver 200 according to one embodiment of the present disclosure is located between the pneumatic plate 220 and the bracket 230 and serves as a hinge about which the pneumatic plate 220 rotates forward and backward.

In addition, the webbing strap 250 of the driver 200 according to one embodiment of the present disclosure is connected to the end of the pneumatic plate 220 and the end of the bracket 230 based on the leg rest pipe 280, which is be described below, and serves to lift the leg rest pipe 280. Specifically, the webbing strap 250 may be formed of a material having tensile force in order to adjust the distance between the pneumatic plate 220 and the bracket 230. For example, the webbing strap 250 may employ a high-strength string with elasticity so as to flexibly lift the leg rest pipe 280. For example, the webbing strap 250 is maintained in a state in which no tensile force is generated, when the seat leg rest 100 does not rotate forward, as shown in FIG. 2B, and generates tensile force and performs a function of lifting the leg rest pipe 280 upward, when the pneumatic plate 220 rotates, as shown in FIG. 3B. In addition, the webbing strap 250 may control the angle of the seat leg rest 100 according to the length of the webbing strap 250. Specifically, the angle at which the seat leg rest 100 rotates may be determined corresponding to the length of the webbing strap 250. For example, when the air bag 210 is inflated, the pneumatic plate 220 may rotate, and the webbing strap 250 may generate tensile force so that the leg rest pipe 280 moves upward and the seat leg rest 100 rotates.

In addition, in some embodiments, the webbing strap 250 may be manufactured to have a longer or shorter length, and the angle at which the seat leg rest 100 rotates may be increased or decreased as the webbing strap 250 is manufactured to have a longer or shorter length.

In addition, a height to which the leg rest pipe 280 is raised forward may be adjusted depending on the length of the webbing strap 250 of the present disclosure, the leg rest link 270 coupled to the leg rest pipe 280 may also be raised forward, and thus, a height to which the seat leg rest 100 is raised may be determined. In addition, since the leg rest pipe 280 may be raised or lowered by the length of the webbing strap 250, the allowable height for raising and lowering the seat leg rest 100 may be predicted, and the position of the seat leg rest 100 may also be regulated.

Further, the pump 260 of the driver 200 according to one embodiment of the present disclosure is provided to supply air into the air bag 210, and serves to supply air into the air bag 210 through the air hose 211, which is described below, by a control signal from the controller 300.

The leg rest link 270 of the driver 200 according to one embodiment of the present disclosure is connected to the seat leg rest 100 and performs a function of lifting the seat leg rest 100 forward. Specifically, when the leg rest pipe 280 is raised, the leg rest link 270 is also unfolded upward. In addition, the leg rest link 270 is coupled to the leg rest pipe 280, and therefore, when the leg rest pipe 280 is raised, the leg rest link 270 is also unfolded, and when the leg rest pipe 280 is lowered, the leg rest link 270 is also folded. In addition, a distance to which the leg rest link 270 moves forward becomes a height to which the seat leg rest 100 is capable of being raised forward by the length of the leg rest link 270, and the leg rest link 270 is raised forward by the height to which the leg rest pipe 280 is lifted by the tensioned webbing strap 250.

In addition, the leg rest pipe 280 of the driver 200 according to one embodiment of the present disclosure is raised along the webbing strap 250, as described above, and the leg rest link 270 coupled to the leg rest pipe 280 is also raised simultaneously so that the angle of the folded leg rest link 270 increases. In addition, the distance to which the leg rest pipe 280 is raised may be adjusted so that the angle of the seat leg rest 100 may be adjusted by a control signal from the Further, referring to FIG. 4 and FIGS. 5A-5D, when air is supplied into the air bag 210 of the driver 200 through the pump 260, the air bag 210 is inflated to increase the distance between the pneumatic plate 220 and the bracket 230, and when air is exhausted from the air bag 210, the air bag 210 is deflated to decrease the distance between the pneumatic plate 220 and the bracket 230.

Hereinafter, specific components for supplying air into the air bag 210 are described.

According to one embodiment of the present disclosure, the air bag 210 of the leg rest device 10 installed in a vehicle includes the air hose 211, an air hose rib 212, an air hose bracket 213, a male connector 214, a female connector 215, a first fastener 217, and a second fastener 218, in order to supply or exhaust air into or from the air bag 210.

First, the air bag 210 of the present disclosure includes the air hose 211, and the air hose 211 serves to supply air into the air bag 210. As shown in FIG. 4, air is drawn in by the pump 260, and moves to the air bag 210 via the air hose 211 under the control of the controller 300. The air hose 211 of the present disclosure may be provided to serve as an air flow path, and be provided as a tube formed of rubber.

In addition, the air hose rib 212 that fixes the path of the air hose 211 so that the air hose 211 may be fixed without being removed may be provided. The air hose rib 212 has holes formed therein, and the holes are provided with the same diameter as the air hose 211. Each hole is formed to be coupled to the air hose 211, and the number of the holes in the air hose rib 212 may be determined according to the number of air hoses 211. In the present disclosure, one air bag 210 and one air hose 211 are described to rotate the seat leg rest 100 forward and backward, but in some embodiments, one or more air hoses 211 may be employed depending on the purpose of the leg rest device 10 or in order to increase the degree of inflation of the air bag 210. Accordingly, the number of the holes in the air hose rib 212 may also be provided to correspond to the number of the air hoses 211. In the present disclosure, the air hose rib 212 may be manufactured to have one or more holes, and the holes excluding the hole to which the air hose 211 is coupled may be used as air hose paths of a pneumatic system for tilting a seat cushion upward and downward. In addition, the first fastener 217 is installed adjacent to the air hose bracket 213 to fix the air hose bracket 213. When a certain component is said to be “adjacent to” another component, this may mean that the certain component is close to, near to, and/or next to the other component, and/or the certain component is disposed within a predetermined distance from the other component.

Further, the male connector 214 and the female connector 215 of the air bag 210 of the present disclosure are located on the lower surface of a seat back 120, and the male connector 214 and the female connector 215 are configured to be connected to the air hose 211 in order to improve workability when performing the work of fixing and removing the seat leg rest 100. As shown in FIG. 4, the male connector 214 and the female connector 215 are coupled to each other between the air hoses 211, thus being capable of implementing a structure capable of preventing air leakage from the air hoses 211.

In addition, the air hose bracket 213 of the present disclosure may be provided with the first fastener 217 so as to be fixed to a frame, and may be fixed to the first fastener 217 to prevent interference with the air hose 211 when the seat leg rest 100 is operated by the driver 200.

FIG. 6 is a flowchart illustrating a driving method of the leg rest device for vehicles according to one embodiment of the present disclosure, and the driving method of the leg rest device according to one embodiment of the present disclosure is described in detail.

In an operation S10, air is supplied into the air bag connected to the air hose of the present disclosure to inflate the air bag. The air bag is inflated, and a reaction force is generated between the bracket and the air bag (in an operation S20). Due to inflation of the air bag, the distance between the pneumatic plate and the bracket increases, and the angle between the pneumatic plate and the hinge pipe increases (in an operation S30). Thereafter, tensile force is generated in the webbing strap coupled to the bracket and the pneumatic plate (in an operation S40). The leg rest pipe located on the webbing strap is lifted due to the tensile force of the webbing strap (in an operation S50). Therefore, the seat leg rest connected to the leg rest pipe rotates forward (in an operation S60). The angle of the seat leg about height direction is measured, and air is supplied again to the air bag based on determining that the measured angle of the seat leg rest is less than a set angle (e.g., 80 degrees). On the contrary, in an operation S70, inflation of the air bag is stopped based on determining that the measured angle of the seat leg rest is greater than or equal to the set angle (e.g., 80 degrees).

In this way, the leg rest device according to one embodiment of the present disclosure may minimize a component package for rotating the seat leg rest through simple driving, i.e., inflation and deflation of the air bag, and may reduce a space in the vehicle where the component package is installed. In addition, a motor for rotating the leg rest device forward is operated through a plurality of link structures, but during this process, interference between members may be prevented and noise generation may be prevented.

Finally, the component package used to implement the leg rest device may be minimized, thus improving workability.

As is apparent from the above description, the present disclosure may obtain the following effects through the configuration, and combination and usage relations disclosed in the above-described embodiments.

One or more embodiments of the present disclosure may reduce a component package for driving a seat leg rest, thus being capable of securing a space within a vehicle.

In addition, one or more embodiment of the present disclosure may cause a motor for rotating a leg rest device forward to be operated through a plurality of link structures, and in this process, may prevent malfunction and noise caused by interference between members.

Finally, one or more embodiment of the present disclosure may solve reduced workability caused by the excessive number of component packages for driving the leg rest device.

The above detailed description is illustrative of the present disclosure. In addition, the above description is intended to illustrate embodiments of the present disclosure, and the present disclosure may be used in various other combinations, modifications, and environments. In other words, it should be apparent to those having ordinary skill in the art that various substitutions, changes and modifications which are not described herein but are still within the spirit and scope of the present disclosure may be made. The described embodiments illustrate various modes for implementing the technical idea of the present disclosure, and various changes required for specific application fields and uses of the present disclosure are also possible. Accordingly, the above detailed description of the disclosure is not intended to limit the present disclosure to the disclosed embodiments. Further, the appended claims should be construed to include other embodiments as well.

What is claimed is:

1. A leg rest device comprising:
a seat leg rest configured to support calves of a passenger;
a driver operatively associated with the seat leg rest and configured to rotate the seat leg rest forward; and
a controller configured to transmit a control signal to the driver to operate the driver,
wherein the driver comprises an air bag, and
wherein the air bag is configured to be inflated by air injected into the air bag based on the control signal from the controller to rotate the seat leg rest forward.

2. The leg rest device of claim 1, wherein, the air bag is configured to be deflated to rotate the seat leg rest backward based on that air is exhausted from the air bag.

3. The leg rest device of claim 1, wherein the driver further comprises:
at least one pneumatic plate coupled to the seat leg rest;
a bracket assembled with the seat leg rest;
a hinge pipe located between the at least one pneumatic plate and the bracket;
a webbing strap connected to ends of the at least one pneumatic plate and the bracket and configured to increase a distance between the at least one pneumatic plate and the bracket;
a pump configured to supply air into the air bag; and
a leg rest link configured to raise the seat leg rest forward by the air bag,
wherein the air bag is provided on the at least one pneumatic plate, and
wherein a reaction force is generated between the at least one pneumatic plate and the bracket through inflation or deflation of the air bag, and the seat leg rest is configured to rotate forward based on the reaction force.

4. The leg rest device of claim 3, wherein the at least one pneumatic plate is configured to be pushed by the air bag, so that tensile force is generated in the webbing strap coupled to the at least one pneumatic plate.

5. The leg rest device of claim 3, further comprising a leg rest pipe coupled to the leg rest link and configured to fold or unfold the leg rest link.

6. The leg rest device of claim 5, wherein the webbing strap is configured to lift the leg rest pipe to raise the leg rest link so that the distance between the at least one pneumatic plate and the bracket increases.

7. The leg rest device of claim 1, wherein the driver further comprises:
a webbing strap configured to adjust a position of the seat leg rest; and
a leg rest link configured to raise the seat leg rest forward,
wherein an angle of the seat leg rest is controlled based on a length of the webbing strap.

8. The leg rest device of claim 1, wherein the air bag is configured to be inflated with air by a pump to push at least one pneumatic plate.

9. The leg rest device of claim 1, wherein the air bag is coupled to an air hose such that air is supplied into or exhausted from the air bag through the air hose based on the control signal from the controller.

10. The leg rest device of claim 9, wherein the air bag comprises an air hose rib configured to prevent the air hose from being removed.

11. The leg rest device of claim 9, further comprising an air hose bracket configured to fix the air hose.

12. The leg rest device of claim 11, further comprising a first fastener configured to fix the air hose bracket to a seat cushion configured to come into contact with at least one thigh of the passenger.

13. The leg rest device of claim 11, further comprising a second fastener configured to fix the air hose to a frame of a vehicle.

14. The leg rest device of claim 9, further comprising:
a male connector connected to the air hose; and
a female connector connected to the male connector,
wherein the air hose is located adjacent to the male connector and the female connector.

15. The leg rest device of claim 9, further comprising an air hose bracket configured to fix a path of the air hose.

16. A driving method of a leg rest device, the driving method comprising:
inflating an air bag connected to an air hose;
generating a reaction force between the air bag and a bracket;
increasing an angle between a hinge pipe and a pneumatic plate located adjacent to the air bag and spaced apart from the bracket;
generating tensile force in a webbing strap coupled to the bracket and the pneumatic plate;
lifting a leg rest pipe;
rotating a seat leg rest forward;
stopping the inflation of the air bag;
measuring an angle of the seat leg rest about height direction;
determining whether the angle of the seat leg rest reaches a set angle; and
inflating the air bag based on a determination that the angle of the seat leg rest does not reach the set angle.

17. The driving method of claim 16, wherein the reaction force between the air bag and the bracket is generated based on inflation of the air bag.

18. A leg rest device comprising:
a seat leg rest configured to support calves of a passenger;
a driver operatively associated with the seat leg rest and including an air bag; and
a controller configured to cause the driver to inflate the air bag to rotate the seat leg rest forward.

19. The leg rest device of claim 18, wherein, the air bag is configured to be deflated to rotate the seat leg rest backward.

20. The leg rest device of claim 1, wherein the driver further comprises:
at least one pneumatic plate coupled to the seat leg rest, wherein the air bag is provided on the at least one pneumatic plate; and
a bracket assembled with the seat leg rest,
wherein a reaction force is generated between the at least one pneumatic plate and the bracket through inflation or deflation of the air bag, and the seat leg rest is configured to rotate forward based on the reaction force.
